(19) United States
(12) Patent Application Publication
(10) Pub. No.: US 2017/0071219 A1
(43) Pub. Date: Mar. 16, 2017

(54) TENDERIZER

(71) Applicant: YOSHIHARU CUTLERY CO., LTD., Gifu (JP)

(72) Inventors: Junya TANAKA, Gifu (JP); Kenji TANAKA, Gifu (JP)

(21) Appl. No.: 15/266,250

(22) Filed: Sep. 15, 2016

(30) Foreign Application Priority Data
Sep. 16, 2015 (JP) 2015-183030

(51) Int. Cl. A22C 9/00

(52) U.S. Cl. CPC A22C 9/008

(57) ABSTRACT

According to an aspect of the embodiment, a tenderizer includes a plurality of blades that cuts meat fibers and/or sinews, and a fixing part that fixes the plurality of blades. At least one of the plurality of blades is attached with a different angle from an attaching angle of at least one of the other of the plurality of blades with respect to a predetermined reference direction on the fixing part.

### BACKGROUND OF THE INVENTION

1. Field of the Invention

The present invention relates to a tenderizer used for cutting meat fibers in preparation for cooking of meat.

2. Description of the Related Art

A conventional tenderizer includes a plurality of blades spaced at certain intervals with one ends disposed on the same arc, and a bow-shaped support member that supports the proximal portions of the plurality of blades. Both ends of the support member are connected via a connecting member serving as a handle. The connecting member serving as a handle is grasped to hold a tenderizer with a hand, and then the tenderizer is rotated while some of the plurality of blades are pressed to a piece of meat. This sequentially presses the plurality of blades to the piece of meat so as to cut the fibers of meat (for example, Japanese Laid-Open Patent Publication No. 2007-089894).

However, in the conventional tenderizer, the plurality of blades for cutting meat fibers are aligned in a row like an arc. The plurality of blades in the row needs to be perpendicularly pressed to meat fibers, which may cause inconvenience. If a user unfamiliar with meat fibers uses the above mentioned tenderizer particularly at home, meat fibers cannot be efficiently cut.

The present invention has been devised in consideration of this problem. An object of the present invention is to provide a tenderizer that can easily and efficiently cut meat fibers.

### SUMMARY OF THE INVENTION

According to an aspect of the embodiment of an invention, which is made to solve the problem described in “Description of the Related Art”, a tenderizer includes a plurality of blades that cuts meat fibers and/or sinews, a fixing part that fixes the plurality of blades, a cover that includes the plurality of blades and the fixing part, and is configured to protrude the plurality of blades from a bottom of the cover when a user press down the cover, a base plate that is pressed to a meat which is a target of cutting the meat fibers, and has a passing means to pass the plurality of blades protruded from the cover and support posts that connect the cover and the base plate with a predetermined distance, and at least one of the plurality of blades is attached with a different angle from an attaching angle of at least one of the other of the plurality of blades with respect to a predetermined reference direction on the fixing part.

The above mentioned tenderizer can easily and efficiently cut meat fibers and/or sinews. Specifically, at least one of the plurality of blades is attached with a different angle from the attaching angle of at least one of the other blades with respect to the predetermined reference direction on the fixing part. It is possible to cut meat fibers and/or sinews easily and efficiently only by pressing down the cover owing to the cover, base plate, and support posts.

When a user holds the fixing part to pierce meat, even if the directions of meat fibers and/or sinews are deviated from the reference direction on the fixing part, at least one of the plurality of blades is attached with a different angle from the reference direction, and thus all the plurality of blades are angled by a certain amount with respect to the directions of meat fibers and/or sinews. Thus, it is possible to cut always meat fibers and/or sinews.

In other words, even for a home user (e.g., a housewife) who is not so familiar with cooking of meat, it is possible to cut meat fibers and/or sinews easily and efficiently.

Moreover, the plurality of blades may be placed in a state of row on the fixing part, and, when using a direction of a row line of the plurality of blades which are fixed in the state of row as the predetermined reference direction, each of the plurality of blades is alternately attached with a predetermined angle with respect to the predetermined reference direction.

In this configuration, when the user holds the fixing part to pierce meat, even if the directions of meat fibers and/or sinews are deviated from the row line along which the plurality of blades of the fixing part are fixed, angles are formed between the row line and the plurality of blades, and this makes it possible to cut meat fibers and/or sinews with higher efficiency.

“Row line direction” means, when the plurality of blades is placed in a state of row, a direction of the row of the plurality of blades.

If a tenderizer includes a plurality tenderizing units, or the plurality tenderizers each of which is a unit of assembly, meat fibers and/or sinews can be more easily and efficiently cut due to a large number of blades angled with respect to the meat fibers and/or sinews.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A, 1B, 1C, 1D and 1E schematically illustrate the shape of a tenderizer of a first embodiment;

FIG. 2A and 2B are explanatory drawings illustrating a method of using the tenderizer of the first embodiment;

FIG. 3 schematically illustrates the configuration of a tenderizer of a second embodiment;

FIG. 4A, 4B, 4C and 4D schematically illustrate the configurations of tenderizers or tenderizing units constituting the tenderizer of the second embodiment;

FIG. 5A and 5B are outside drawings schematically illustrating an attachment of the second embodiment;

FIG. 6A and 6B schematically illustrate the configuration of the attachment of the second embodiment;

FIG. 7A and 7b are explanatory drawing illustrating a method of using the tenderizer of the second embodiment; and

FIG. 8A, 8B, 8C and 8D are outside drawings schematically illustrating a tenderizer of other embodiments.

### DETAILED DESCRIPTION OF THE INVENTION

Embodiments according to the present invention will be described below with reference to the accompanying drawings. The present invention is not limited to the following embodiments, and can be changed in various ways within the technical scope of the present invention.

### First Embodiment

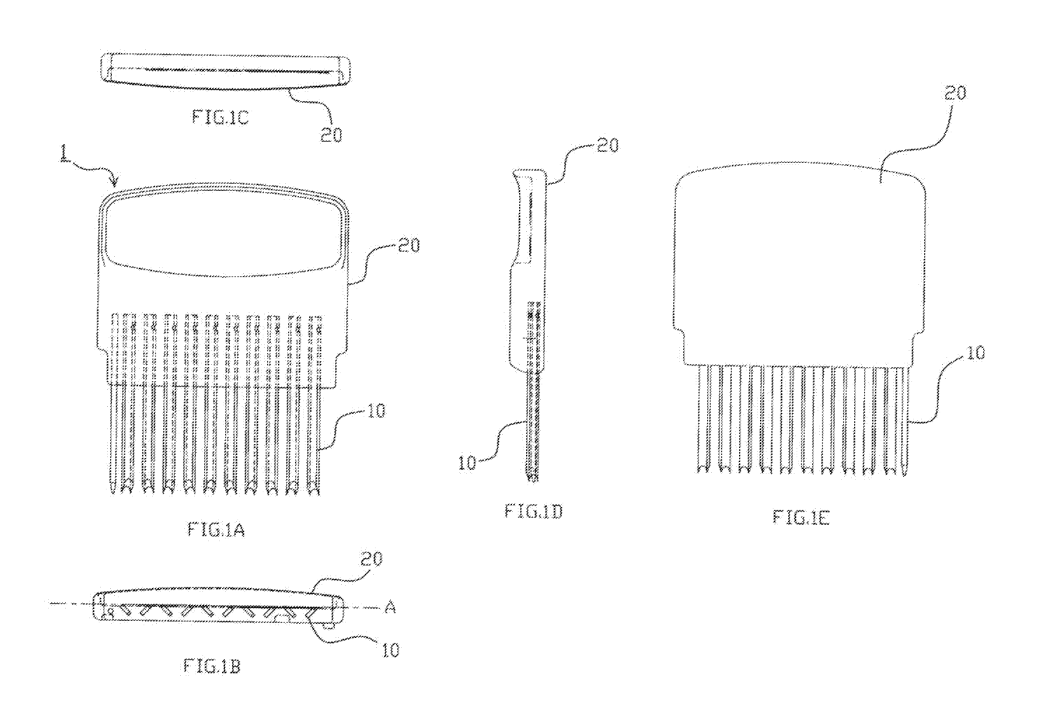

FIGS. 1A to 1E are schematic diagrams illustrating the shape of a tenderizer 1, especially a meat tenderizer 1 which has blades, i.e., a blade tenderizer. FIG. 1A is a front view, FIG. 1B is a bottom view, FIG. 1C is a plan view, FIG. 1D is a side view, and FIG. 1E is a back view. As illustrated in FIG. 1A, the tenderizer 1 includes a plurality of blades 10 and a fixing part 20.

The plurality of blades 10 are made of a metal, e.g. stainless steel suitable for cutting tools, are formed into elongated shapes, and are provided with cutting edges, which are formed (so-called sharpening) for cutting meat fibers on one width ends (distal ends) of the plurality of blades 10. Fibers may include sinews. The tenderizer 1 or the plurality of blades 10 cuts fibers, or sinews, or both of fibers and sinews.

The fixing part 20 is a member for linearly fixing the other width ends (opposite ends to the distal ends on which the plurality of blades is formed) of the plurality of blades 10, which is a set of cutters or tooth. The fixing part 20 is made of a resin material such as plastic. As illustrated in FIG. 1D, the fixing part 20 fixes the plurality of blades 10, and is curved inward substantially at the center of the upper half so as to be easily held by a user with a hand.

As illustrated in FIG. 1B, each of the plurality of blades 10 is alternately attached with a predetermined angle with respect to a row line direction (reference direction) along which the plurality of blades 10 is fixed in a state of row on the fixing part 20. This angle is determined depending on the kind of meat containing fibers and/or sinews to be cut. Typically, this angle is set at about 45 degrees with respect to a row line A (that is, the two adjacent blades 10 form an angle of about 90 degrees).

“Row line” means, when the plurality of blades 10 is placed on a straight line, the straight line of a direction along which the plurality of blades 10 is placed. Specifically, in FIG. 1B, the row line A corresponds to the above row line. When the plurality of blades 10 is curved in a horizontal plane, the direction of placing the plurality of blades 10 is a direction of a line which connects both distal ends of the plurality of blades 10.

(Method of Using the Tenderizer 1)

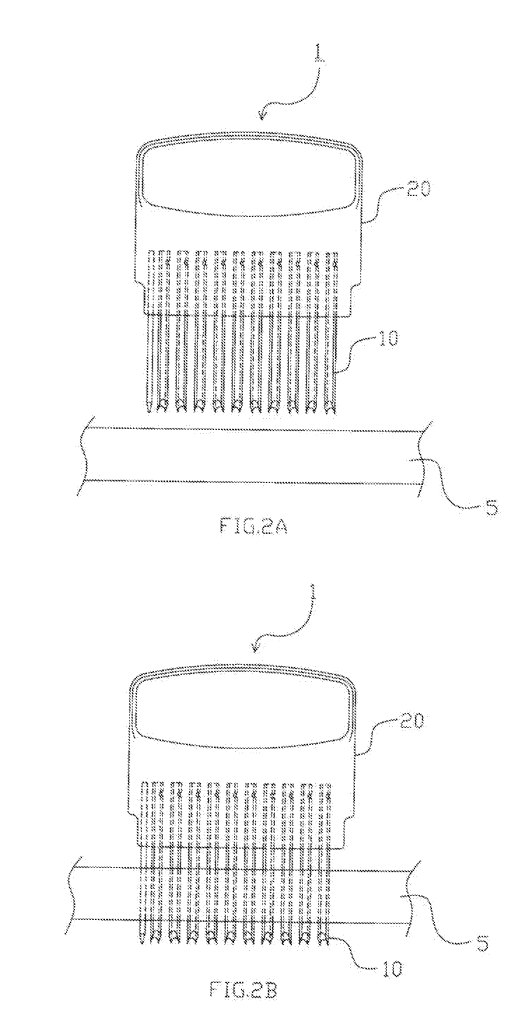

Referring to FIGS. 2A and 2B, a method of using the tenderizer 1 will be discussed below. FIGS. 2A and 2B are explanatory drawings illustrating the method of using the tenderizer 1.

As illustrated in FIG. 2A, the user holds the fixing part 20 of the tenderizer 1, and presses the plurality of blades 10 to a surface of meat 5. At this point, the tenderizer 1 is pressed to the surface of the meat 5 such that the fibers of the meat 5 extend in the same direction (row line) with a direction of which the plurality of blades 10 is placed.

Subsequently, as illustrated in FIG. 2B, the fixing part 20 is pressed to pass the plurality of blades 10 through the meat 5. This process makes it possible to cut the fibers of the meat 5.

This process is repeated over the entire meat 5 so as to cut the fibers of the overall meat 5.

(Structure of the Tenderizer 1)

In the above mentioned tenderizer 1, the plurality of blades 10, which is elongated, is attached to the fixing part 20 in the state of row by fixing one width ends of each of the plurality of blades 10. Each of the plurality of blades 10 is alternately attached to the fixing part 20 with the predetermined angle with respect to the row line along which the plurality of blades 10 is fixed in the state of row.

Thus, when the user holds the fixing part 20 and pierces meat, even if the directions of meat fibers are deviated from the row line along which the plurality of blades 10 of the fixing part 20 is fixed, it is possible to cut meat fibers due to angles between the row line and the plurality of blades 10. In other words, even for a home user (e.g., a housewife) not so familiar with cooking of meat, it is possible to easily and efficiently cut meat fibers.

### Second Embodiment

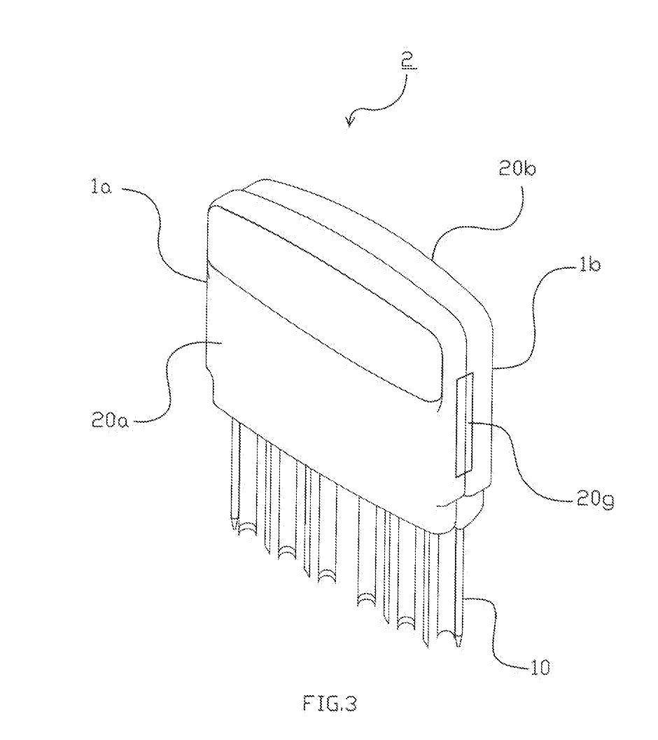

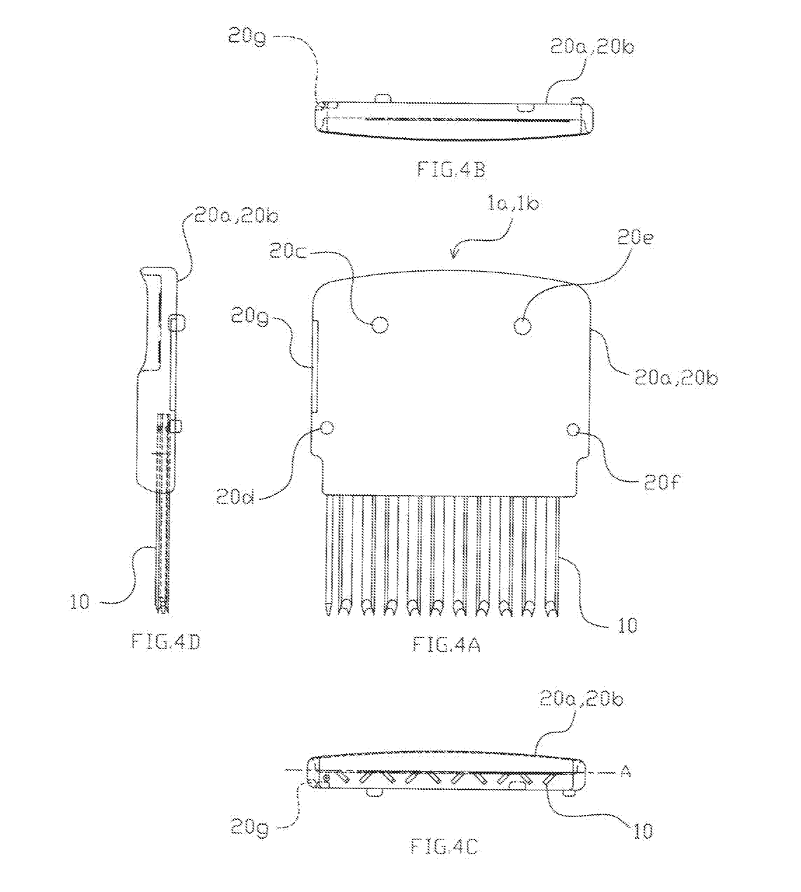

Referring to FIGS. 3 and 4, a tenderizer 2 of a second embodiment will be described below. FIG. 3 is an outside drawing schematically illustrating the tenderizer 2. FIGS. 4A to 4D schematically illustrate the configuration of tenderizers 1a and 1b, or tenderizing units 1a and 1b, both of which constitute the tenderizer 2, and is a unit of assembly. FIG. 4A is a back view, FIG. 4B is a plan view, FIG. 4C is a bottom view, and FIG. 4D is a side view.

As illustrated in FIG. 3, the tenderizer 2 of the second embodiment includes a plurality of the tenderizing units, in other words, the two tenderizers 1 (hereinafter, called tenderizers 1a and 1b) of the first embodiment. The tenderizers 1a and 1b are combined and used in such manner that a row line for attaching the plurality of blades 10 of the tenderizer 1a to the fixing parts 20a and a row line for attaching the plurality of blades 10 of the tenderizer 1b to the fixing parts 20b are placed in parallel.

As illustrated in FIGS. 4A to 4D, the tenderizers 1a and 1b each have convex portions 20c and 20f provided on the upper left and lower right on the back sides of the fixing parts 20a and 20b, and concave portions 20d and 20e provided on the lower left and upper right so as to fit onto the convex portions 20c and 20f, respectively. Moreover, a notch 20g is provided on each of the opposing sides of the fixing parts 20a and 20b.

Subsequently, the back sides of the tenderizers 1a and 1b are brought into contact with each other to fit the convex portions 20c and 20f into the concave portions 20d and 20e. Thus, the tenderizer 1a and the tenderizer 1b are combined and used as the tenderizer 2.

If the combined tenderizer 1a and tenderizer 1b are separated to be cleaned with ease, the notches 20g provided on the sides of the fixing parts 20a and 20b are used.

Specifically, the notch 20g is caught by a nail or the cutting edge of a knife to separate the tenderizer 1b from the tenderizer 1a. This makes it easy to disassemble the tenderizer 2.

In the second embodiment, a user does not hold the fixing parts 20a and 20b of the tenderizer 2, and an attachment 30 for inserting the tenderizer 2 into meat is used instead.

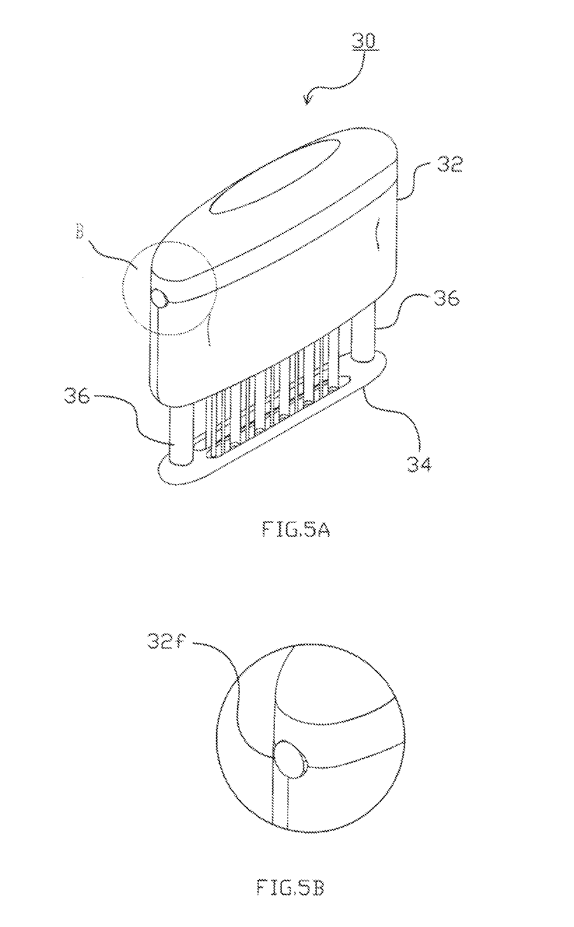

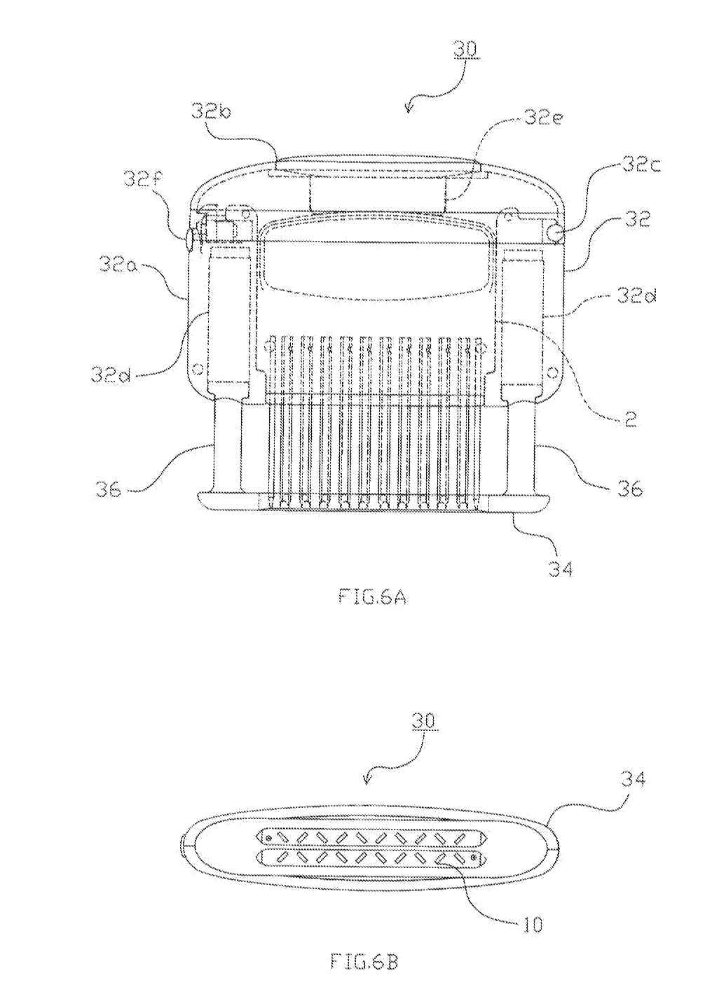

Referring to FIGS. 5A, 5B, 6A, and 6B, the attachment 30 will be discussed below. FIGS. 5A and 5B are outside drawings schematically illustrating the attachment 30. FIG. 5A is a perspective view of the attachment 30. FIG. 5B is an enlarged view of a button 32f. FIGS. 6A and 6B schematically illustrate the configuration of the attachment 30. FIG. 6A is a front view and FIG. 6B is a bottom view.

As illustrated in FIG. 5A, the attachment 30 includes a cover 32, a base plate 34, and support posts 36.

As illustrated in FIG. 6A, the cover 32 includes a main unit 32a and a head unit 32b. The main unit 32a is a member that accommodates the tenderizer 2. The main unit 32a is made of a resin material, e.g., plastic, and is substantially oval in plane cross section so as to cover the sides of the tenderizer 2. The top face and bottom of the main unit 32a are opened.

The head unit 32b is gradually curved upward so as to cover the opening on the top face of the main unit 32a.

As illustrated in FIG. 6A, a hinge 32c is provided on one end of the main unit 32a and the head unit 32b. Thus, the head unit 32b is possible to rotate on the hinge 32c.

A hook is provided on the opposite end of the head unit 32b from the hinge 32c. Moreover, a lock mechanism (not illustrated) for locking/unlocking the hook (not illustrated) and a button 32f for releasing the lock mechanism are provided on the opposite end of the main unit 32a from the hinge 32c.

In a state that the tenderizer 2 is set into the main unit 32a, the head unit 32b is pressed to hang the hook of the head unit 32b on the lock mechanism of the main unit 32a, and, thus, the head unit 32b is fixed to the main unit 32a.

For removal of the tenderizer 2, the button 32f (see FIG. 5B) is pressed to release the lock mechanism, and unlock the hook. This makes it possible that the head unit 32b rotates on the hinge 32c to open the head unit 32b, and then the tenderizer 2 removes from the opening on the top face of the main unit 32a.

A height of the cover 32 in a state that the head unit 32b is closed in the main unit 32a, in which the tenderizer 2 is set inside, is so high as to hide about one third of the fixing part 20 in the longitudinal direction of the plurality of blades 10.

Moreover, as illustrated in FIG. 6A, the main unit 32a is provided with cylindrical parts 32d on both ends (along two ellipse vertices having small curvatures) of the main unit 32a such that the two support posts 36 can be inserted into the respective cylindrical parts 32d. The head unit 32b further includes a pressing member 32e that presses the top of the tenderizer 2, when the tenderizer 2 is assembled in.

The base plate 34 is made of a plate material, e.g., plastic, and is molded into substantially the same shape (i.e., an ellipse) as the plane cross section of the cover 32. Furthermore, holes are formed in the central part of the base plate 34 so as to allow the passage of the plurality of blades 10 of the tenderizer 2.

The cylindrical support posts 36 are made of a resin material, e.g., plastic, and are attached to both ends (along two ellipse vertices having small curvatures) of the base plate 34.

The two support posts 36 are inserted into the cylindrical parts 32d of the cover 32. Between the top of the support post 36 and the cylindrical part 32d, a coil spring (not illustrated) is inserted.

The insertion of the support posts 36 into the cylindrical parts 32d allows the cover 32 to vertically slide along the cylindrical parts 32d serving as guides.

(Method of Using the Tenderizer 2)

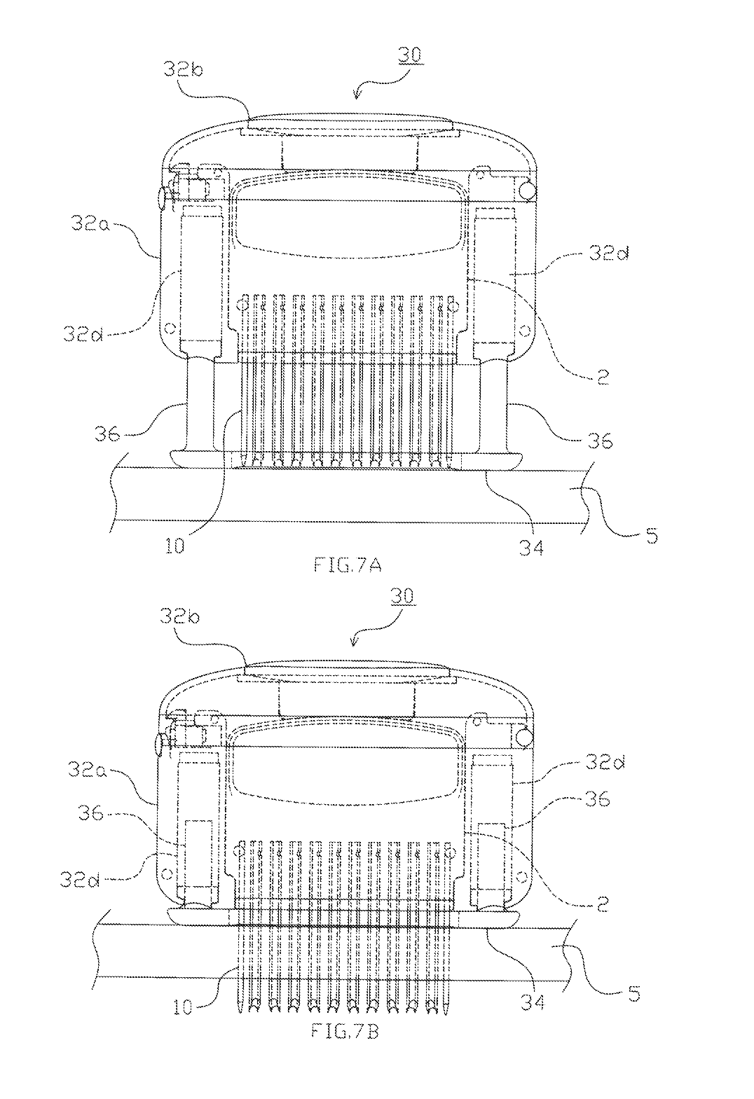

Referring to FIGS. 7A and 7B, a method of using the tenderizer 2 assembled into the attachment 30 will be discussed below. FIGS. 7A and 7B are explanatory drawings illustrating the method of using the tenderizer 2.

(1) As illustrated in FIG. 7A, the attachment 30 (tenderizer 2) is placed on a surface of meat 5 such that the back side of the base plate 34 of the attachment 30 is in contact with the surface of the meat 5. At this point, the tenderizer 2 is placed on the surface of the meat 5 such that the fibers of the meat 5 extend in the same direction (row line) with a direction of which the plurality of blades 10 is placed.

(2) Subsequently, as illustrated in FIG. 7B, the cover 32 of the attachment 30 is pressed down with a hand to insert the plurality of blades 10 into the meat 5. This process makes it possible to cut the fibers of the meat 5.

(3) When the hand is released from the cover 32, by the spring force of the coil spring (not illustrated) in the cover 32, the plurality of blades 10 of the tenderizer 2 is pulled out from the meat 5 (then, returns to the state of FIG. 7A).

(4) The attachment 30 is moved to another part of the meat 5, and then steps (1) to (3) are repeated to cut the fibers of the overall meat 5.

(Structures of the Tenderizer 2 and the Attachment 30)

The tenderizer 2 is configured to thus includes the two tenderizers 1 of the first embodiment as the two tenderizing units. Thus, when viewed from the bottom, the plurality of blades 10 is placed like letters X or rhombuses (see FIG. 6B). Specifically, meat fibers can be cut such that a predetermined region of meat is surrounded by the four blades 10. This structure makes it possible to cut meat fibers more easily and efficiently.

Meat fibers can be easily and efficiently cut only by pressing the cover 32 while the attachment 30 presses the base plate 34 to the meat 5.

Moreover, when the tenderizer 2 removed from the attachment 30, it is possible to disassemble the tenderizer 2 into the two tenderizers 1a and 1b. This makes it possible to facilitate maintenance such as cleaning of the plurality of blades 10.

Furthermore, since the notches are opposed to each other on one side of the fixing part 20 of the tenderizers 1, when the tenderizer 2 is disassembled into the two tenderizers 1a and 1b, a force is applied to the notch 20g so as to easily separate the tenderizers 1a and 1b. This makes it possible to facilitate maintenance such as cleaning.

### Third Embodiment

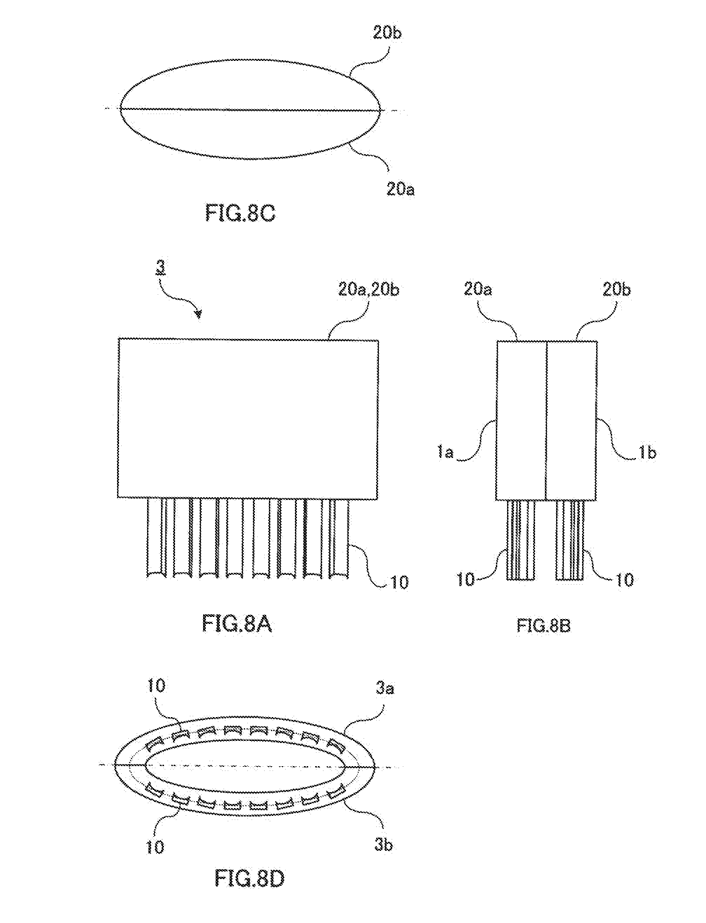

Referring to FIGS. 8A to 8D, a tenderizer 3 of a third embodiment will be described below. FIGS. 8A to 8D are outside drawings schematically illustrating the tenderizer 3. FIG. 8A is a front view, FIG. 8B is a side view, FIG. 8C is a plan view, and FIG. 8D is a bottom view.

As illustrated in FIGS. 8A to 8D, the tenderizer 3 includes two tenderizers 3a and 3b combined with each other. As illustrated in FIG. 8C, the tenderizer 3 is oval in plan view. In other words, combined fixing parts 20a and 20b are oval in plan view.

As illustrated in FIG. 8D, the tenderizer 3 includes a plurality of blades 10 having cutting edges which are placed along the tangential direction of the center line (a broken line in FIG. 8D) of the oval shape of the combined fixing parts 20a and 20b in plan view.

In the third embodiment, unlike in the first and second embodiments, even if the plurality of blades 10 is not placed on a straight line, but is placed like a curve, it is possible for an unskilled user to efficiently cut, because meat fibers extend in a different direction from the direction of attaching the plurality of blades 10.

In this case, a reference direction may be a center row line in the longitudinal direction of an ellipse indicated by “C” illustrated in FIG. 8D, and may be the attaching direction (tangential direction) of any one of the plurality of blades 10.

### Other Embodiments

(1) In the first and second embodiments, the plurality of blades 10 is attached at an angle of 45 degrees with respect to the row line (in other words, the two blades 10 form an angle of 90 degrees). However, the two blades 10 may form other angles, for example, 45 degrees to 135 degrees depending on the kind of meat which contains fibers to be cut.

(2) In the second embodiment, the support posts 36 are attached to both ends of the base plate 34. However, the base plate 34 and the support posts 36 may be made as separate members respectively, and the support posts 36 may be attached to the base plate 34 with screws or the like. Alternatively, the base plate 34 and the support posts 36 may be molded into one member by resin molding such as injection molding.

(3) In the second embodiment, the notches 20g are provided on one sides of the fixing parts 20a and 20b. However, the notches 20g may be provided on both sides. Because of this structure, it is possible to easily disassemble the tenderizer 2, since the tenderizers 1a and 1b can be separated by applying a force to the above both sides.

(4) In the above embodiments, the plurality of blades 10 and the fixing part 20 are separate members. However, for example, the plurality of blades 10 and the fixing part 20 may be integrated into one unit by processing such as stamping out them of a metallic plate.

All examples and conditional language recited herein are intended for pedagogical purpose to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A tenderizer comprising:
a plurality of blades that cuts meat fibers;
a fixing part that fixes the plurality of blades;
a cover that includes the plurality of blades and the fixing part, and is configured to protrude the plurality of blades from a bottom of the cover when a user press down the cover;
a base plate that is pressed to a meat which is a target of cutting the meat fibers, and has a passing means to pass the plurality of blades protruded from the cover; and
support posts that connect the cover and the base plate with a predetermined distance,
wherein at least one of the plurality of blades is attached with a different angle from an attaching angle of at least one of the other of the plurality of blades with respect to a predetermined reference direction on the fixing part.

2. The tenderizer according to claim 1,
wherein the plurality of blades is placed in a state of row on the fixing part, and
wherein, when using a direction of a row line of the plurality of blades which is fixed in the state of row as the predetermined reference direction, each of the plurality of blades is alternately attached with a predetermined angle with respect to the predetermined reference direction.

3. A tenderizer comprising:
a plurality of tenderizing units, each of which further comprises:
a plurality of blades that cuts meat fibers;
a fixing part that fixes the plurality of blades;
a cover that includes the plurality of blades and the fixing part, and is configured to protrude the plurality of blades from a bottom of the cover when a user press down the cover;
a base plate that is pressed to a meat which is a target of cutting the meat fibers, and has a passing means to pass the plurality of blades protruded from the cover; and
support posts that connect the cover and the base plate with a predetermined distance,
wherein at least one of the plurality of blades being attached with a different angle from an attaching angle of at least one of the other of the plurality of blades with respect to a predetermined reference direction on the fixing part.

4. The tenderizer according to claim 3,
wherein the plurality of blades is placed in a state of row on the fixing part, and
wherein, when using a direction of a row line of the plurality of blades which is fixed in the state of row as the predetermined reference direction, each of the plurality of blades is alternately attached with a predetermined angle with respect to the predetermined reference direction.
